(19) United States
(12) Patent Application Publication
(10) Pub. No.: US 2006/0208140 A1
(43) Pub. Date: Sep. 21, 2006

(54) Electrical device

(75) Inventor: Steve Reichel, Kuppenheim (DE)

Correspondence Address: SIEMENS CORPORATION;INTELLECTUAL PROPETY DEPARTMENT, 170 WOOD AVENUE, SOUTH, ISELIN, NJ, 08830, US

(73) Assignee: SIEMENS AKTIENGESELLSCHAFT

(21) Appl. No.: 11/365,986

(22) Filed: Mar. 1, 2006

(30) Foreign Application Priority Data
Mar. 3, 2005 (DE) 10 2005 009 798.7

(51) Int. Cl. F16M 11/00

(52) U.S. Cl. 248/161

(57) ABSTRACT

An electrical device is proposed, in particular an LCD display, which comprises a housing base, onto which a rear panel can be mounted. Measures are provided, which thereby allow a simple releasable locking of the rear panel. The assembly time of the rear panel is shortened both during production and also during onsite services.

### CROSS REFERENCE TO RELATED APPLICATIONS

This application claims priority to the German Application No. 10 2005 009 798.7, filed Mar. 3, 2005 which is incorporated by reference herein in its entirety.

### Field of Invention

The invention relates to an electrical device, in particular an LCD display, with a housing base, onto which a rear panel can be mounted.

### BACKGROUND OF INVENTION

LCD displays are normally provided with a housing base, onto which a rear panel can be mounted. A backlight, an LCD display, a reflector and further parts required for the operation of the LCD module are essentially arranged in this housing base. During operation the light of the backlight illuminates the LCD display, said LCD display essentially comprising diffuser films and/or polarization films as well as LCD glass and LCD liquid. The rear panel is normally mounted onto the housing base with screws or snap-on connections, this disadvantageously impacts the assembly time both during production as well as during onsite servicing.

### SUMMARY OF INVENTION

An object underlying the present invention is to provide an electrical device of the type mentioned at the start, the rear panel of which can be easily assembled and disassembled without a tool.

This object is achieved in that the rear panel is provided with locking elements on two opposite sides, said locking elements can be inserted into corresponding recesses of the housing base, with the locking elements and the recesses being provided for the releasable locking of the rear panel with the housing base, in that the rear panel features positioning elements on a further side, which can be inserted into further corresponding recesses of the housing base, with the positioning elements being provided in order to position the rear panel on the housing base and in that the further side of the rear panel is designed to be elastic such that the locking elements can be moved from a locked position into a release position or from the release position into the locked position.

Measures of this type considerably reduce the time required for assembly and disassembly of the rear panel.

In one embodiment of the invention provision is made to design the locking elements to be L-shaped, these being easy to implement in terms of production.

### BRIEF DESCRIPTION OF THE DRAWINGS

The invention, along with its expansion and developments, is described and elaborated in further detail on the basis of the drawing, in which an exemplary embodiment of the invention is illustrated, in which;

FIG. 1 shows top view of a rear panel of an LCD module

FIG. 2 shows the side view of a rear panel and

FIG. 3 shows a mounting plate of a housing base

Identical parts illustrated in the figures are provided with the same reference characters.

### DETAILED DESCRIPTION OF INVENTION

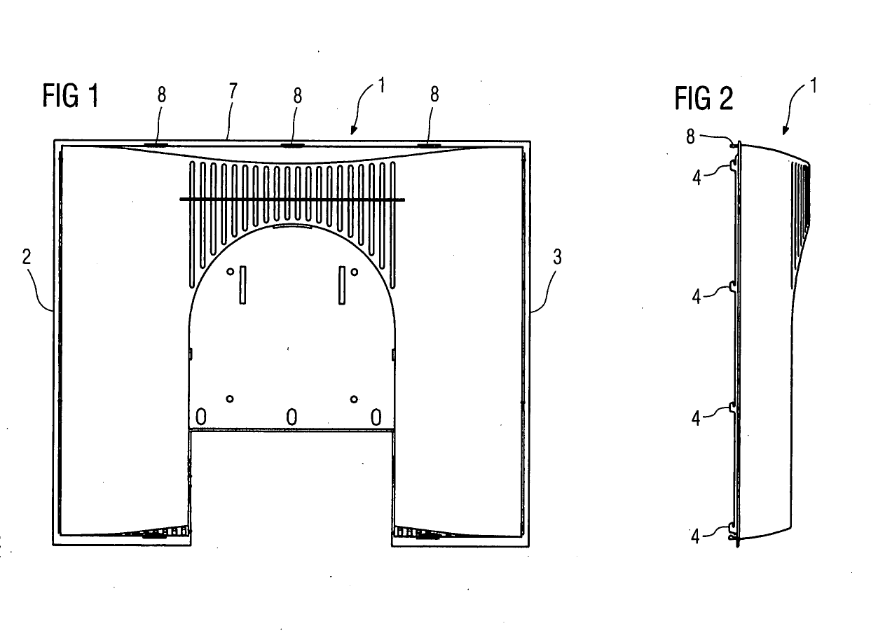

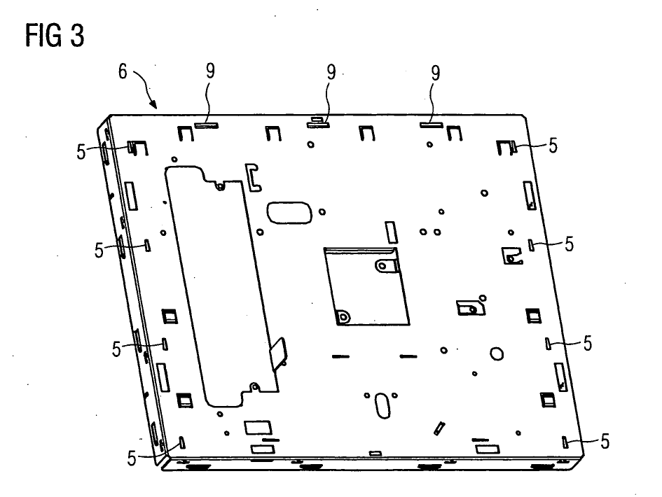

A housing rear panel is indicated by the number 1 in FIG. 1, said housing rear panel being able to be assembled in a housing base. In addition, the rear panel 1 essentially features L-shaped locking elements 4 on two opposing sides 2, 3, (FIG. 2) which interact with corresponding recesses 5 of a mounting plate 6 (FIG. 3) of the housing base and which can be inserted into these recesses 5. Positioning elements 8 are arranged on another elastically designed side 7 of the rear panel 1, by means of which the rear panel 1 can be positioned onto the housing base, with the mounting plate 6 of the housing base being provided with recesses 9 corresponding to these positioning elements 8.

The rear panel is assembled on the mounting plate 6 in such a manner that the positioning elements 8 of the rear panel 1 are first inserted into the recesses 9. The locking elements 4 are positioned above the recesses 5 of the mounting plate 6 by means of a slight external force exerted on the elastic side 7 in the direction of the side of the rear panel 1 opposite this side 7, with the locking elements 4 being inserted into these recesses 5 by means of a slight pressure exerted in the direction of the recesses 5. The L-shaped locking elements finally engage the recesses 5 in a locked position if no force is acting upon the elastic side 7.

The rear panel 1 can be released from the mounting plate 6 by again a force first acting on the elastic side 7 in the direction of the side of the rear panel 1 opposite this side 7. This moves the locking elements 4 in a release position, in which the L-shaped locking elements 4 no longer engage with the recesses 5 and the rear panel 1c an be lifted up.

1.-2. (canceled)

3. An electrical device, comprising:
a housing base configured to support a rear panel;
a rear panel having locking elements on two opposing sides of the rear panel, the locking elements configured to be inserted into corresponding first recesses arranged on the housing base, the locking elements and the first recesses allowing for a releasable locking of the rear panel on the housing base; and
positioning elements arranged on a further side of the rear panel, the positioning elements configured to be inserted into corresponding second recesses arranged on the housing base, the positioning elements configured to position the rear panel on the housing base, wherein the further side of the rear panel is elastic such that the locking elements are movable from a locked position into a release position or from the release position into the locked position.

4. The electrical device according to claim 3, wherein the electrical device is an LCD display.

5. The electrical device according to claim 3, wherein the locking elements are L-shaped.
